(19) United States
(12) Patent Application Publication
(10) Pub. No.: US 2006/0282477 A1
(43) Pub. Date: Dec. 14, 2006

(54) Computer aided design file validation system

(76) Inventors: Timothy J. Gruidl, Edina, MN (US); Rod Blesener, Bloomington, MN (US); Tim Otremba, St. Paul, MN (US)

Correspondence Address: PAULY, DEVRIES SMITH & DEFFNER, L.L.C., P.O. BOX 2960, MINNEAPOLIS, MN, 55402-2960, US

(21) Appl. No.: 11/328,848

(22) Filed: Jan. 10, 2006

Related U.S. Application Data
(60) Provisional application No. 60/687,652, filed on Jun. 3, 2005.

(51) Int. Cl. G06F 17/30

(52) U.S. Cl. 707/201

(57) ABSTRACT

A method and system of validating the integrity of a multi-file computer aided design database is disclosed. In certain embodiments the method includes providing a database containing multiple objects including multiple subordinate computer aided design objects, each subordinate object defining one or more components for use in a multi-component assembly; and multiple dominant objects, each dominant object defining a multi-component assembly, said dominant objects requiring the use of one or more subordinate objects. The integrity of each of the identified dominant objects is validated to determine whether any changes in the subordinate objects have caused defects in dominant objects.

This application claims the benefit of U.S. Provisional Application No. 60/687652, filed Jun. 3, 2005, the contents of which are herein incorporated by reference.

### FIELD OF THE INVENTION

The present invention is directed to systems and methods of validating the integrity of a computer aided design database containing multiple files for three dimensional objects.

### BACKGROUND

Associative solid modeling using 3D CAD modeling systems has gained broad acceptance in design and manufacturing environments. Associative modeling systems are defined by the ability to reference geometry among components of an assembly, allowing the identification of components (such as fasteners) by reference. This allows components to be used within multiple assemblies with ease.

One problem with associative solid modeling using 3D CAD modeling systems is that components are used in multiple assemblies, and failure in some of those assemblies can occur if a component is changed. The inherent nature of associative solid modeling involves creating relationships that often break as changes occur. The time end users spend cleaning up “bad” data is rarely measured and usually unnoticed by management. The impact is significant and results in reduced productivity and slow turnaround times. For example, a component might be changed so as to work in a first assembly, but thereby becomes unusable in another assembly.

Some organizations utilizing associative solid modeling seek to prevent these multi-assembly problems by implementing standards and checkers on the saving or storing of the data. Adding Value with Methodology¹ discusses the benefits of the standards for creation and storing. While it is beneficial to standardize the data going into the system, it does not solve the problem of whether or not a modified component will create a failure in other assemblies.

The present invention addresses this problem by providing an automated, systematic process of verifying the ongoing integrity of a 3D CAD database and notifying the users of errors resulting from their CAD modeling.

### SUMMARY OF THE INVENTION

The present invention is directed, in part, to a method of validating the integrity of a multi-file computer aided design database, the method comprising providing a database containing multiple objects, including multiple subordinate and dominant computer aided design objects. Each subordinate object defines one or more components for use in a multi-component assembly. Each dominant object defines a multi-component assembly. The dominant objects require the use of one or more subordinate objects. The various dominant objects can require some of the same subordinate objects, such that each dominant object may have one or more common subordinate object with one or more of the various other dominant objects.

The method further includes identification of modified subordinate objects that have changed within a defined period, identification of dominant objects requiring the use of one or more modified subordinate objects, and validation of the integrity of each of the identified dominant objects to determine how the change in the subordinate object impacts the dominant object.

The method can include reporting multiple aspects of the relationship between dominant and subordinate objects, including their status, as well as any failures that have occurred in validating the integrity of the objects or other failures. Notification methods, such as a reporting system utilizing emails or instant messages or other automatic notification procedures, can optionally be incorporated into some embodiments of the invention.

Generally the method further includes confirmation that each dominant object is usable by a computer aided design program using the modified subordinate objects. Validating the integrity of each of the identified dominant objects comprises, in some embodiments, includes determining whether the geometry of the component or components defined by the subordinate objects is usable within each dominant object. For example, such determination can include determining the state of the object, such as it will open or opens with errors, and the nature of the errors when it does open with errors.

The method can include retaining multiple copies of one or more of the subordinate objects in the database, said multiple copies being identifiable by version or revision history. Using these various versions of the subordinate objects, it is possible to validate each subordinate object to determine the most recent functioning subordinate object for each dominant object. Thus, the method can comprise validating multiple copies of multiple subordinate objects. Said methods can optionally include identification of the most recent functioning subordinate object and making said subordinate object available for display by a computer aided design user.

In some implementations the method includes identification of the most recent functioning subordinate object and displaying said subordinate object simultaneously with the most recent subordinate object. This implementation can further comprise providing for replacement of the most recent subordinate object with the most recent functioning subordinate object.

The above summary of the present invention is not intended to describe each disclosed embodiment or every implementation of the present invention. The Figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is diagram of a simplified hierarchy of objects in a 3D CAD modeling environment.

FIG. 2 is a schematic diagram showing elements of an example verification system made in accordance with an implementation of the invention.

FIG. 3 is a flowchart showing steps of a verification process undertaken in accordance with an implementation of the invention.

FIG. 4 is a flowchart showing additional steps of a verification process undertaken in accordance with an implementation of the invention, in particular functioning of the CAD worker module.

### DETAILED DESCRIPTION

The present invention is directed, in part, to a software tool that allows 3D Computer Aided Design (CAD) users to assess and validate the integrity of their CAD data. The software tool can be configured to support multiple CAD systems and data managers, and is thus optionally CAD system independent. The software tool provides a wealth of reporting options, as well as optionally great flexibility in configuration, such as scheduling time, frequency, and files to validate. In certain embodiments the systems and methods include the ability to distribute work to multiple computers. The software tool can include a web based front end that serves as the user interface for configuring the system. Due to the complexity of the methods performed by the system, consolidating the user interface into one, or just a few, screens can have significant advantages.

A. Overview

As noted above, the present invention allows for validation of the integrity of files made using a 3D CAD system. Generally the method comprises providing a database containing multiple objects, including multiple subordinate and dominant computer aided design objects. Each subordinate object defines one or more components for use in a multi-component assembly. Each dominant object defines a multi-component assembly. The dominant objects require the use of one or more subordinate objects. The various dominant objects can require some of the same subordinate objects, such that each dominant object may have one or more common subordinate object with one or more different dominant objects. The method further includes identification of modified subordinate objects that have changed within a defined period, identification of dominant objects requiring the use of one or more modified subordinate objects, and validation of the integrity of each of the identified dominant objects to determine how the change in the subordinate object impacts the dominant objects.

Validating the integrity of each of the identified dominant objects comprises, in some embodiments, determining whether the geometry of the component or components defined by the subordinate objects is usable within each dominant object. For example, such determination can include determining the state of the object, such as it will open, opens with errors, and the nature of the errors when it does open with errors. In some embodiments the method includes retaining multiple copies of one or more of the subordinate objects in the database, said multiple copies being identifiable by version/revision history; and further comprising validating each of said multiple copies of each subordinate object to determine the most recent functioning subordinate object for each dominant object requiring the subordinate object. The method can comprise validating multiple copies of multiple subordinate objects.

Methods of assessing and validating the CAD files can optionally include identification of the most recent functioning subordinate object and making said subordinate object available for display by a computer aided design user. In some implementations the method includes identification of the most recent functioning subordinate object and displaying said subordinate object simultaneously with the most recent subordinate object. This can further comprise providing for replacement of the most recent subordinate object with the most recent functioning subordinate object. The objects can be both dominant and subordinate. The system can further include a query server that connects to the database and handles query requests from the verification server.

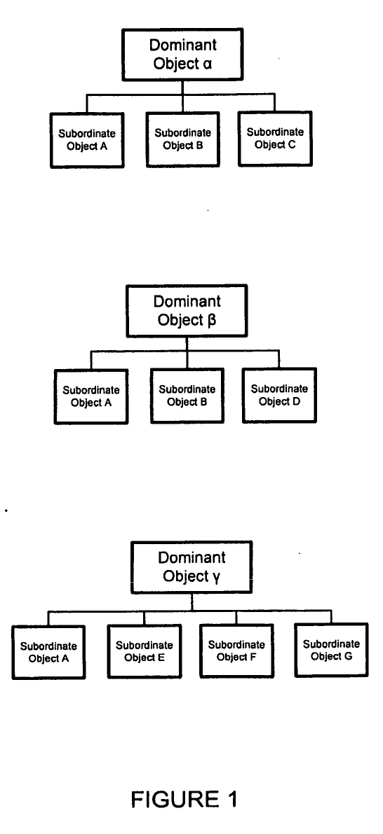

In reference now to FIG. 1, an example of the relationship between various dominant and subordinate objects is depicted. FIG. 1 shows three dominant objects: dominant object α, dominant object β, and dominant object γ. Each of these dominant objects has multiple subordinate objects. In the case of dominant object α, the subordinate objects are: subordinate object A, subordinate object B, and subordinate object C. In the case of dominant object β, the subordinate objects are: subordinate object A, subordinate object B, and subordinate object D. In the case of dominant object γ, the subordinate objects are: subordinate object A, subordinate object E,. subordinate object F, and subordinate object G.

Thus, in this illustrative example, all three dominant objects contain the common subordinate object A. It may be, during the design process, that one or more of these subordinate objects are modified, and any such modification can impact the dominant objects that incorporate the changed subordinate object. For example, if subordinate object A is changed, it can impact dominant object α, dominant object β, and dominant object γ. However, if subordinate object B is changed, this change will only impact dominant object α and dominant object β, since only these two dominant objects (of the three shown) contain the subordinate object B. Similarly, only one of each of the three dominant objects in FIG. 1 is impacted by each of the subordinate objects C, D, E, F, and G. A change in any of these subordinate objects will only impact one of these three dominant objects.

A purpose of the present invention is to systematically identify when one or more subordinate objects has been changed, and then to determine whether there has been any disruption of related dominant objects. Using FIG. 1, it is possible to illustrate such issues by using a basic example in which the dominant and subordinate objects are part of an automobile assembly, in particular parts of hinge assemblies, wherein each of the objects corresponds to the following mechanical components:

| Object | Mechanical Component |
|---|---|
| Dominant Object α | Hinge assembly for left door |
| Dominant Object β | Hinge assembly for right door |
| Dominant Object γ | Hinge assembly for trunk |
| Subordinate Object A | Pin |
| Subordinate Object B | First hinge plate |
| Subordinate Object C | Second hinge plate |
| Subordinate Object D | Third hinge plate |
| Subordinate Object E | Fourth hinge plate |
| Subordinate Object F | Fifth hinge plate |
| Subordinate Object G | Spring |

In this example, the three dominant objects correspond to the left door, right door, and trunk of the automobile. Each of these dominant objects contains multiple parts, but for simplicity only some of those parts are shown in this example. All of these hinge assemblies represented by the three dominant objects contain a common pin identified as subordinate object A, which is the only common component between the three hinges. However, both dominant object α and dominant object β have a common first hinge plate identified as object B, while they each also have an additional hinge plate identified as subordinate objects C and D. The dominant object γ contains two distinct hinge plates identified as subordinate objects E and F, as well as a spring identified as subordinate object G.

It will be appreciated that a change in the pin (subordinate object A) may have an impact on any one of the three hinge assemblies, since all of them utilize the same pin. Assuming each hinge plate is configured to receive the pin, a change in these hinge plates can affect all hinge assemblies that incorporate that pin. If the pin is changed in dimension, such as by increasing its diameter, then that pin may not fit into openings in each of the hinge plates, thereby causing failure in one or more of the hinge assemblies. In such cases the changing of the pin (subordinate object A) results in failures of all three dominant objects α, β, and γ.

In other situations, the modification of one subordinate object will result in limited failure of other dominant objects. For example, a change may be made in the first hinge assembly (subordinate object B) to allow it to function better with the second hinge assembly (subordinate object C). However, it is possible that this change, while being tolerated by dominant object α, may result in failure of dominant object β if the change creates a conflict with the third hinge plate (subordinate object D). This change in the first hinge assembly (subordinate object B) would not create a failure in dominant object γ because dominant object γ does not contain the first hinge assembly.

It will be appreciated that the foregoing explanation of an example embodiment is provided only to show a simplified illustration of how the present system and method functions, but in most implementations the functionality is likely to include far more dominant and subordinate objects.

B. System Elements

The system of the present invention typically includes a database on which resides information about multiple dominant and subordinate objects. The database can include, for example, the regularly stored files of the CAD system, or can include a derivative of these files that can be used to determine their integrity. Thus, the database can include multiple CAD files, or even a single CAD file defining multiple objects. Dominant objects, as defined above, contain information about various subordinate objects. The system can be configured in various ways to perform the verification of the integrity of the dominant objects. However, in most embodiments this includes a database, either distributed across multiple computers or resident on one computer. This database is queried using either a distributed or centralized architecture to identify objects requiring validation, then these are validated and an output of errors is generated. In certain embodiments this output of errors can be expanded to include further information about potential corrective measures.

Generally the system includes a verification processor that connects to the database, retrieves the CAD files and runs the verification. It returns status and error information to the CAD worker module and writes results to a verification log file.

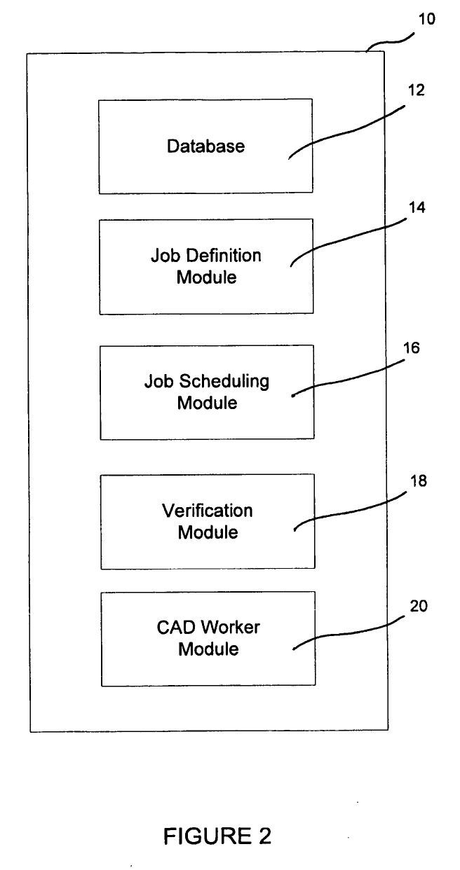

Described below, and shown in FIG. 2, are examples of various components of systems used for performing the present invention. This system 10 includes the database 12, plus various modules, including a job definition module 14, a job scheduling module 16, a verification module 18, and a CAD worker module 20. In some implementations, each of these modules is accessed through the web based front end. In addition, in some implementations, all reports and log files are accessible through the same user interface. The functions of these modules can be combined such that fewer modules are needed than shown in FIG. 2. In the alternative, the functions of these modules can be divided into separate modules or sub-modules so that more modules are used than shown in FIG. 2. Furthermore, it is possible to have different modules so long as the claimed invention, described herein, is performed.

Verification Server the Verification

Job Definition Module

The job definition module will often have a variety of features that can be configured to the specific validation job being performed. These features can include, for example, the date range of dominant and subordinate objects to be checked, the file types to be checked, the database source (such as specific folders or subfolders to be checked), and the level of verification to be undertaken (such as to checking all dominant objects or a subset of dominant objects). Additional job definition information can also be included, such as the name of the verification job and how it is to be saved and retrieved.

Job Scheduling Module

Generally the system and method of the invention allow for scheduling of verification jobs to be undertaken at preset times. The schedule can include both the specific time for initiating the verification job, as well as the files to be verified. For example, all files can be periodically verified, or just some of the files can be verified. It may be desirable to only verify those files that have changed within the last 24 hours, last week, or last month in certain implementations. The job scheduler can be, for example, a Java based component that defines the time frame for a job definition to be run. It can allow for begin date, start time, and recurrence definition. It also optionally allows schedules to be saved to support multiple job schedules.

Job scheduling features of the system can be handled by a job scheduling module, which can be used to make determinations of job selection, provide an on-demand option, plus a date to initiate a validation job and the starting time for the validation job. The scheduling module can further include for recurrence of validation jobs.

Verification Module

The verification module allows configuration of verification features, including identification of suppressed components, frozen components, and packaged components; the ability to accomplish full regeneration, looking for circular references, interchange groups, assembly external references, assembly missing references, part external references, missing part references, geometric checks, and duplicate objects.

CAD Worker Module

Certain embodiments of the invention further include a CAD worker module, which is a Java component that serves as the communication link between the verification server and the verification processor. The CAD worker module takes requests from the verification server and passes them to the verification process.

C. Validation Methodology

The present invention is directed to a method and system for validating the integrity of a multi-file computer aided design database. The method and system allow rapid, automatic confirmation that the multi-file computer aided design database does not contain defective assemblies. The method comprises providing a database containing multiple objects including multiple subordinate computer aided design objects, each subordinate object defining one or more components for use in a multi-component assembly; and multiple dominant objects, each dominant object defining a multi-component assembly, said dominant objects requiring the use of one or more subordinate objects.

The method further includes identification of modified subordinate objects that have changed within a defined period, identification of dominant objects requiring the use of one or more modified subordinate objects, and validating the integrity of each of the identified dominant objects to determine how the change in the subordinate object will impact the dominant object. In certain implementations of the invention the methods can optionally be performed in a distributed environment or a single localized environment.

The method can include reporting multiple aspects of the dominant and subordinate objects, including their status, as well as any failures that have occurred in validating the integrity of the objects or other failures. Notification methods, such as a reporting system utilizing emails or instant messages or other automatic notification procedures, can optionally be incorporated into some embodiments of the invention. In certain implementations the method further includes validating the integrity of each of the identified dominant objects comprises confirmation that each dominant object can be usable by a computer aided design program using the modified subordinate objects.

An example implementation of the process of the invention is described below. The verification task is initiated at the start program step. During operation, a job is initiated by the verification server based on the schedule. Once initiated, the verification server sends a query to the query server, which queries the database for the list of items to be verified. The verification server builds a verification queue and sends verification requests to the CAD workers. Each CAD worker passes the request to its local verification processor. After the verification processor has received the request, it connects to the database, retrieves the requested dominant object and its dependent subordinate objects, and runs the requested verification. After the verification has been completed, the verification processor sends success or error status to the CAD worker and writes results to its local log file. The error status can be, for example, that a file failed to properly open or it opened improperly. The verification server continues this process until the queue is empty.

The verification server can be, for example, a Java based component responsible for running and monitoring all jobs. In an example embodiment, it utilizes job scheduling, job definition and CAD worker information to initiate, manage and monitor the verification job.

As noted herein, the system and methods of the present invention can also embody various job definitions that allow for customization of the scope and content of a verification job. In one embodiment the system includes a job definition module that is a Java based component that defines what CAD files are to be verified. This component can connect to the database to allow the user to interactively select specific folders to include in the verification job. Date ranges, file types, release level and verification level can also be defined. In one implementation the job definition module allows jobs to be saved to support multiple job definitions.

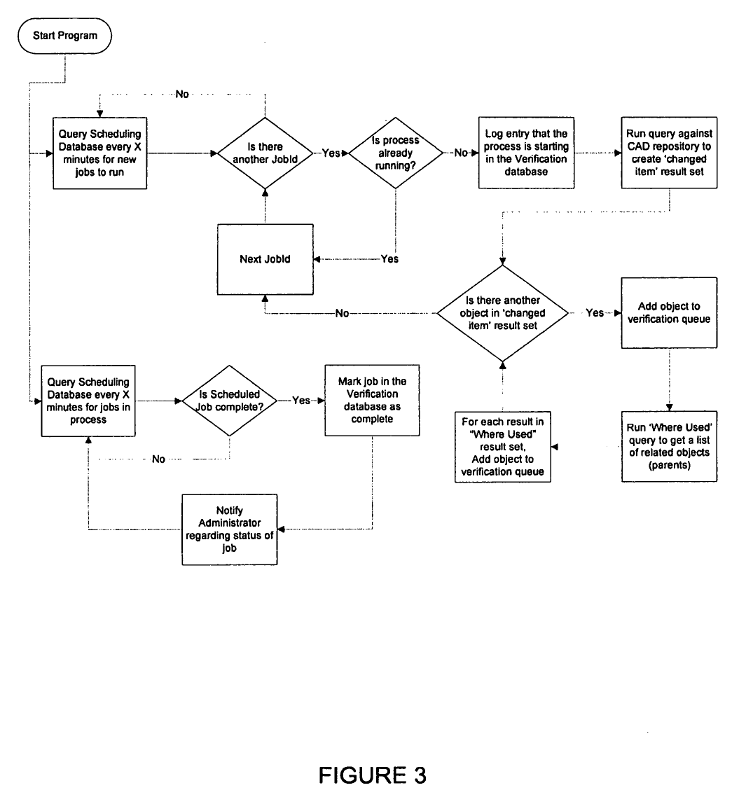

FIG. 3 shows an example process using an implementation of the present invention, beginning with a start program command. In this implementation, the start program command leads to a query of a scheduling database every X minutes (defined by the user) for new jobs to run and jobs in progress. The query for new jobs to run assesses whether there is another JobId. If there is not another JobID, then the process returns to step to wait X minutes for a new job to run. If there is a JobID at at the assessment, then a determination is made on whether the process is already running, if it is not, then a log entry is made that the process is starting in the verification database, and a query is run against a CAD repository to create a “changed item” result set. This changed item result set identifies which objects (such as subordinate and dominant objects as defined herein) have been changed according to prescribed rules (such as changed since the last verification of the database). These changed items are subsequently added to the verification queue. If there are no changed items left, then the next JobId can be processed. The objects that have been added to the verification queue are subsequently run in a “where used” query to determine a list of related objects (typically dominant objects, also referred to as “parents”). For each result from this “where used” query, the identified objects are added to the verification queue. In this manner the objects in the verification queue include both those identified by revision date, as well as those identified as being dependent upon revised objects (using the “where used” query).

The method further includes queries to a scheduling database every X minutes for jobs in process, to determine if the scheduled jobs have been completed. Once a job has been completed, the job is marked in the verification database as complete, and the administrator is notified regarding the status of that job.

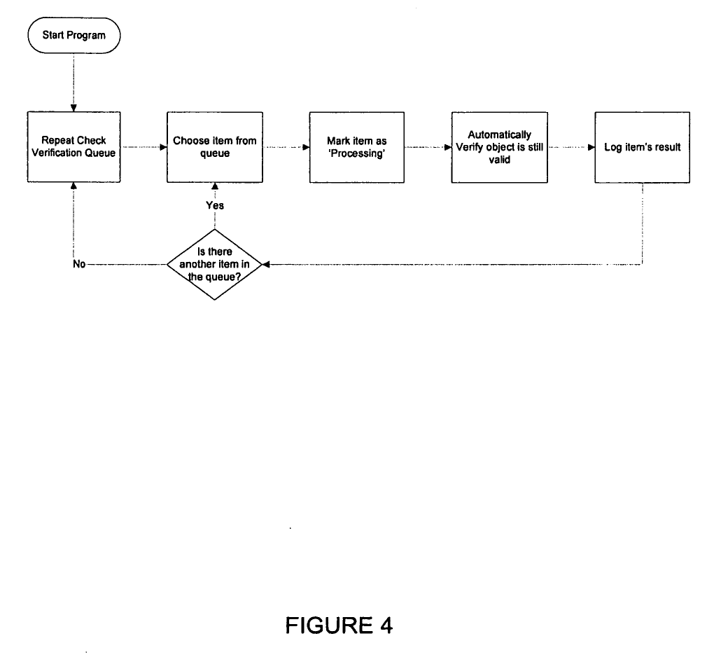

Referring now to FIG. 4, a flowchart is depicted showing additional steps of a verification process undertaken in accordance with an implementation of the invention, in particular functioning of the CAD worker module. The CAD worker module chooses items from the verification queue, identifies it as being processed, and then verifies that the object is valid. Thereafter the item's result is logged, and any subsequent items in the queue are processed.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

We claim:

1. A method of validating the integrity of a multi-file computer aided design database, the method comprising:
a) providing a database containing multiple objects including:
(i) multiple subordinate computer aided design objects, each subordinate object defining one or more components for use in a multi-component assembly; and
(ii) multiple dominant objects, each dominant object defining a multi-component assembly, said dominant objects requiring the use of one or more subordinate objects;
b) identification of modified subordinate objects that have changed within a defined period;
c) identification of dominant objects requiring the use of one or more modified subordinate objects; and
d) validating the integrity of each of the identified dominant objects.

2. The method of claim 1, wherein validating the integrity of each of the identified dominant objects comprises confirmation that each dominant object can be opened by a computer aided design program using the modified subordinate objects.

3. The method of claim 1, wherein validating the integrity of each of the identified dominant objects comprises determining whether the geometry of the component or components defined by the subordinate objects is usable within each dominant object.

4. The method of claim 1, further comprising:
a) validating multiple copies of one or more of the subordinate objects, said multiple copies being identifiable by revision history; and
b) further comprising validating each of said multiple copies of each subordinate object to determine the most recent functioning subordinate object for each dominant object requiring the subordinate object.

5. The method of claim 4, further comprising identification of the most recent functioning subordinate object and making said subordinate object available to a computer aided design user.

6. The method of claim 5, further comprising identification of the most recent functioning subordinate object, reporting and displaying said subordinate object simultaneously with the most recent subordinate object.

7. The method of claim 6, further comprising providing for replacement of the most recent subordinate object with the most recent functioning subordinate object.

8. The method of claim 1, further comprising validating multiple copies of one or more dominant objects, said multiple copies being identifiable by chronological order.

9. The method of claim 1, wherein certain objects are both dominant and subordinate.

10. A method of validating the integrity of a multi-file computer aided design database, the method comprising:
a) providing a database containing multiple objects including:
(i) multiple subordinate computer aided design objects, each subordinate object defining one or more components for use in a multi-component assembly; and
(ii) multiple dominant objects, each dominant object defining a multi-component assembly, said dominant objects requiring the use of one or more subordinate objects;
b) identification of modified subordinate objects that have changed within a defined period;
c) identification of dominant objects requiring the use of one or more modified subordinate objects; and
d) validating the integrity of each of the identified dominant objects by confirmation that each dominant object can be opened by a computer aided design program using the modified subordinate objects;
e) validating multiple copies of one or more of the subordinate objects, said multiple copies being identifiable by revision history to determine the most recent functioning subordinate object for each dominant object requiring the subordinate object.

11. The method of claim 10, further comprising identification of the most recent functioning subordinate object and making said subordinate object available to a computer aided design user.

12. The method of claim 10, further comprising identification of the most recent functioning subordinate object, reporting and displaying said subordinate object simultaneously with the most recent subordinate object.

13. The method of claim 10, further comprising providing for replacement of the most recent subordinate object with the most recent functioning subordinate object.

14. The method of claim 10, wherein certain objects are both dominant and subordinate.

15. A method for error checking a computer aided design database for multi-component assemblies, the method comprising:
providing a database containing multiple objects including multiple subordinate computer aided design objects, each subordinate object defining one or more components for use in a multi-component assembly; and multiple dominant objects, each dominant object defining a multi-component assembly, said dominant objects requiring the use of one or more subordinate objects;
validating the integrity of each of the identified dominant objects, wherein validation comprises determining whether the geometry of the component or components defined by the subordinate objects is usable within each dominant object; and
generating an output of error conditions.

16. The method of claim 15, further comprising validating multiple copies of one or more dominant objects, said multiple copies being identifiable by chronological order.

17. The method of claim 15, wherein certain objects are both dominant and subordinate.

18. The method of claim 15, wherein validating the integrity of each of the identified dominant objects comprises identification of which subordinate objects cause error conditions.

19. The method of claim 18, which comprises interchanging multiple subordinate objects based upon revision history of the subordinate objects to determine the most recent functioning subordinate object.

20. The method of claim 15, wherein the output of error conditions includes a listing of dominant objects identified as lacking integrity, plus any changed subordinate objects having caused the lack of integrity.
